(19) United States
(12) Patent Application Publication
(10) Pub. No.: US 2013/0163077 A1
(43) Pub. Date: Jun. 27, 2013

(54) LIGHT MICROSCOPY METHOD AND A KIT FOR CARRYING OUT THE METHOD WITH A LIGHT MICROSCOPE

(71) Applicant: William Neuberg, Perrineville, NJ (US)

(72) Inventor: William Neuberg, Perrineville, NJ (US)

(21) Appl. No.: 13/333,259

(22) Filed: Dec. 21, 2011

(51) Int. Cl. G02B 21/06

(52) U.S. Cl. 359/385

(57) ABSTRACT

Described herein is a kit that includes at least one press for pressing matter that is being observed by a light microscope and a method of pressing the matter using the press while the matter is being observed. The press includes a pestle that is supported between, and for independent motion relative to the objective of the microscope and a sample residing on the stage of the microscope.

### FIELD OF THE INVENTION

The present invention relates to microscopy and more particularly to a light microscopy method and a kit that includes at least one press that may be used with a light microscope to deform a sample and allow for simultaneous observation of the deformation of the sample.

### BACKGROUND OF THE INVENTION

There are tools for viewing and monitoring of a material under deformation. One well known tool employs two diamond anvils having flat surfaces positioned directly opposite one another. To use the tool, a sample of a material can be placed between the opposing flat surfaces of the diamond anvils and the anvils are biased against one another to deform the material. A microscope or the like may then be used to observe the effect of the deformation on the sample. Examples of diamond anvils can be found in U.S. Pat. Nos. 4,260,397 and 3,895,313. In these devices, pressure may be applied through a lever system. See Diacell® LeverDAC-Mini, available from www.easylab.co.uk.

Another conventional device has been disclosed by McCrone. The McCrone device employs a tube that is clamped to the objective of the microscope directly and thus moves with the objective of the microscope. Consequently, pressure cannot be applied with this device independently of the objective and its relative position to the sample.

Milosevic et al. (Milosevic), U.S. Pat. No. 5,308,983, discloses a spectroscopic accessory with a microscope illuminator. The microscope disclosed by Milosevic includes a vertical light tube having an ocular and an objective. The microscope further comprises a transparent sapphire wear tip and a device for applying pressure to a sample, which includes a spring, to urge the light tube towards a surface of the sample, the amount of applied pressure being manually adjustable by a knob. The transparent wear tip allows the sample to be observed while pressure is being applied. In the device disclosed by Milosevic, the ocular and the objective are integrated with the tube. Thus, the movement of the tube will cause the movement of the ocular and the tube. Therefore, the pressing mechanism in Milosevic does not move independently of the microscope objective.

Nanbu, JP2003130772A, discloses a fracture strength measuring instrument. The instrument includes a loading means having a transparent plate that is arranged to compress a sample while allowing the sample to be observed by a microscope. In one example, Nanbu appears to disclose a sleeve for supporting a transparent plate. The sleeve is disposed around the objective of the microscope. It appears that Nanbu teaches that a compressive force is imparted by the movement of the stage on which the sample is residing.

Borucki, U.S. Pat. No. 7,869,027, discloses an arrangement including a confocal microscope, and a device that presses a sample. The device includes a transparent window, which allows observation of the sample while the sample is being pressed. While Borucki discloses a pressing device that moves independently of the objective of a microscope, it does not disclose a pressing device arranged at the objective side of the microscope and movable toward the sample residing on the microscope stage independent of the objective and the stage.

Hoult et al. (Hoult), U.S. Patent Publication No. 2008/0285122 discloses an accessory for Attenuated Total Internal Reflection (ATR) Spectroscopy. The accessory includes an anvil, a plate for supporting a sample, and a crystal that includes a sample contacting surface. A pressure mechanism presses against an upper wall of the anvil. The sample can be observed through the crystal. Hoult does not disclose a pressing device arranged at the objective side of the microscope and movable toward the sample residing on the microscope stage independent of the objective and the stage.

Ue et al. (Ue), U.S. Patent Publication No. 2008/0043325 discloses a motorized microscope stage. Ue does not disclose a pressing device arranged at the objective side of the microscope and movable toward the sample residing on the microscope stage independent of the objective and the stage.

Chu, U.S. Pat. No. 6,703,247, discloses slideholders. Chu does not disclose a pressing device arranged at the objective side of the microscope and movable toward the sample residing on the microscope stage independent of the objective and the stage.

Kameshima, JP 4177853, discloses a device for pressing a sample. The device includes a base and a spring loaded press. The sample is disposed between the base and the spring loaded press. The Abstract of Kameshima does not disclose using this device with a light microscope. In its figures, Kameshima does not appear to disclose a pressing device arranged at the objective side of the microscope and movable toward the sample residing on the microscope stage independent of the objective and the stage.

In addition, objective shields are known. One known objective shield is A 10PO, provided by Olympus. The objective shield can be assembled onto an objective of a microscope and includes a transparent window through which the objective can receive light. The transparent windows in the A 10PO includes an outer surface which is recessed relative to the distal end of the shield. Consequently, the transparent window cannot make contact with a sample and cannot be used to deform the sample.

### DEFINITION

The terms light microscopy and optical microscopy are sometimes used interchangeably although light microscopy may better describe the optics involved. The terms microscope or microscopy as used herein refer to light microscope and light microscopy respectively.

### SUMMARY OF THE INVENTION

An object of the present invention is to deform a sample while observing the effects of deformation on a sample using conventional light or optical microscopy.

Another object of the present invention is to provide a kit that includes at least a press which can be used with a conventional microscope to facilitate the observation of deformation of a sample. A kit according to the present invention can include a single press and associated accessories, a plurality of different presses having different configurations for different applications, or a plurality of presses configured for different applications and associated accessories.

A press in a kit according to the present invention includes a pestle having a bearing surface that is placed in contact with a sample residing on the stage of a microscope in registration with the objective lens of the microscope. The pestle is moved relative to the objective and urged against the sample in order to deform the sample while the sample is being observed by the operator.

The pestle may be integrated with a support, or may be integrated with a pestle holder which is coupled to the support. The pestle holder may be made of a magnetically susceptible material so that it may be magnetically coupled to the support for easy replacement and interchargeability, the pestle holder or the pestle may be glued or frictionally coupled to the support, or a flexible gasket or the like may be used to couple the pestle or a pestle holder to the support. The pestle holder may be provided with a needle shaft capable of receiving a needle.

The support may be configured to frictionally couple to the exterior surface of the objective so that it may be manually moved (rotated, moved along its longitudinal axis, or both simultaneously) relative to the objective by the operator, or it may be supported on a platform and configured for motion relative to the objective through a cooperative arrangement with the platform. For example, the support may be threadably coupled to the platform and rotated so that it may move longitudinally relative to the platform while rotating in order to press and shear the sample. The press may also be spring loaded so that it may press the sample, or may be prevented from motion along its longitudinal axis while enabled for rotation along its longitudinal axis to shear the sample.

A pestle suitable for a press in a kit according the present invention may be an optically transparent body such as a glass cover slip, or a sapphire window. A pestle may also be a solid, non-transparent body having a light path therein. For example, the pestle may be a pen tip from which the ball is removed or some other suitable body that includes a passage for light.

A kit according to any one of the disclosed embodiments enables an operator to deform a material and to observe the deformation simultaneously using a microscope. A kit according to the present invention may be employed in the investigation of the properties of solids, liquids, gases and maybe even plasmas, if such materials can be studied using light microscopy. Organic, inorganic, biological, mineralogical, and the like materials may be investigated by employing a press in a kit according to the present invention and methods described herein for the use of a press in a kit according to the present invention. Anything that can be seen with a microscope may be studied using a press in a kit according to the present invention including crystals, polymers whether liquid, solid, or semi-solid, fluids such as wet ink, films such as dried ink, biological materials, particulate materials, and so on. A kit according to the present invention can enable a microscopist to observe the effects of axially applied pressure on a sample, the effects of shearing on a sample, or the effects of the simultaneous application of axial pressure and shearing. Observation of deformation under pressure, shear, or the combination of pressure and shear can lead to useful information. For example, parts of a grape may be studied to determine which cells produce desired flavors in wine. Ink on paper may be studied to observe the effect of each on trapping. Different liquids may be observed to see how they mix under the shear component of pressing. Gasses such as air separate from both solids and liquids when pressed and can be seen as voids. In short, the effect of deformation may be observed on many different materials for many different reasons. Negative crushability may provide useful information as well. In most applications, the sample can be removed after deformation for further analysis, thus utilizing a press as disclosed herein as a preparative device.

As will be appreciated by a skilled person upon review of the disclosed invention, a kit according to the present invention is simple to use and versatile.

While pressing is disclosed as a preferred method for deformation of a sample, the present invention is equally applicable in tribological, rheological, biological, analytical modes leading to deformation of a material using a press in a kit according to the present invention. A microscopist may be called upon to investigate many properties of many materials. The value of a microscopist is in his/her knowledge of optical principles (for example distinguishing materials by their index of refraction) as well as the microscopist's ability to recognize the appearance of all samples previously seen using all the microscopical techniques with which the microscopist is familiar. There are microscopists who investigate the tactile feel of a material by manipulating the material with a needle. The smaller the particle under investigation by manipulation, the fewer are the number of microscopists qualified to assess the tactile property of the material. A press in a kit according to the present invention may also allow more people to use microscopy in investigating the tactile properties of a material.

Other features and advantages of the present invention will become apparent from the following description of the invention which refers to the accompanying drawings.

### BRIEF DESCRIPTION OF THE DRAWINGS

FIGS. 1A (bottom plan view) and 1A′ (cross-sectional view taken along line 1A′-1A′ and viewed in the direction of the arrows) illustrate a press that includes a pestle and a support for a kit according to the first embodiment of the present invention assembled on an objective of a microscope.

FIGS. 1B (bottom plan view) and 1B′ (cross-sectional view along line 1B′-1B′ viewed in the direction of the arrows) illustrate a press for a kit according to the second embodiment of the present invention assembled on an objective of a microscope.

FIG. 1C illustrates, in a disassembled state, a press for a kit according to the third embodiment of the present invention, the press including a pestle, a pestle holder, and a support.

FIG. 1D illustrates a variation of a press according to the third embodiment in an assembled state according to one configuration.

FIG. 1E illustrates another variation of a press according to the third embodiment in an assembled state.

FIG. 1F illustrates, in a disassembled state, a variation of a press for a kit according to the second embodiment of the present invention, the press having features to prevent rotation of the pestle holder relative to the support and a magnetic coupling arrangement for fixing the pestle holder to the support.

FIG. 2A illustrates a bottom plan view of a pestle integrated with a pestle holder.

FIG. 2B illustrates a cross-sectional view of an example of a pestle and a pestle holder arrangement as would be seen along line 2B-2B in FIG. 2A when viewed in the direction of the arrows.

FIG. 2C illustrates a cross-sectional view of another example of a pestle and a pestle holder arrangement as would be seen along line 2B-2B in FIG. 2A when viewed in the direction of the arrows.

FIG. 2D illustrates a cross-sectional view of a further example of a pestle and a pestle holder arrangement as would be seen along line 2B-2B in FIG. 2A when viewed in the direction of the arrows.

Note that pestles 10 in the arrangements shown in FIGS. 2B-2D have different diameters. Reducing the diameter of a pestle allows for exertion of more pressure on the sample while increasing the diameter may allow for better smearing of the sample. Thus, a kit according to the present invention may include pestles 10 of different diameters to allow the operator/investigator to perform different experiments on the material that is under study.

FIG. 2E illustrates a cross-sectional view of another variation of a pestle and a pestle holder arrangement as would be seen along a line taken along the diameter of the pestle holder, and the line crossing the longitudinal axis of the pestle, the pestle having a frusto conical portion.

FIGS. 2F and 2F′ illustrate a bottom plan view and a cross-sectional view (taken along line 2F′-2F′ and viewed in the direction of the arrows) respectively of a pen tip suitable for use as a pestle with a frusto conical portion.

FIG. 2F″ illustrates a plan view of a pestle illustrated by FIGS. 2F and 2F′ in a pestle holder (see FIG. 2E) received in a support.

FIG. 2G illustrates another variation of a pestle and pestle holder arrangement in which the pestle holder includes a needle shaft for receiving a needle.

FIG. 3A illustrates, in a disassembled state, a press for a kit according to a fourth embodiment of the present invention, the press including a pestle (or a pestle holder) and a support having a thread on its exterior surface.

FIG. 3B illustrates, in a disassembled state, a press for a kit according to a fifth embodiment of the present invention, the press including a pestle (or a pestle holder), and a support in a sleeve having a thread on the exterior surface thereof, the support being fixed against longitudinal motion relative to the sleeve but free to rotate relative to the sleeve.

FIG. 3C illustrates, in a disassembled state, a press for a kit according to the sixth embodiment, the press including a pestle (or a pestle holder), and a support received in a sleeve having a thread on the exterior surface thereof, the support being spring loaded and free to move in a longitudinal direction relative to the sleeve.

FIG. 3C′ illustrates a side plan view of the arrangement illustrated in FIG. 3C viewed in the direction of the arrow 3C to show the slot formed in the support.

FIG. 3C″ illustrates a plan view of an arrangement illustrated in FIG. 3C viewed in the direction of arrow 3C″.

FIG. 4A and 4B illustrate a top plan view and a side plan view respectively of a slide holder that may be included in a kit according to the present invention.

FIG. 5A illustrates a top plan view of a support platform which can be used with any one of the presses shown in FIGS. 3A, 3B and 3C.

FIG. 5B is a side plan view in the direction of arrow 5B in FIG. 5A.

FIG. 5C is a cross-sectional view along line 5C-5C in FIG. 5A, viewed in the direction of the arrows.

FIG. 5D illustrates a support arrangement as depicted in FIGS. 5A-5C in which the stage is heated/cooled.

FIG. 5D′-5D″″ illustrates views of a Linkham® Hot/Cold stage in a closed state (FIG. 5D′), in an open state (FIG. 5D″), with its lid in a closed state (FIG. 5D″′), with its lid removed (FIG. 5D″″) and with a lid configured to receive a press according to any one of the presses illustrated in FIGS. 3A, 3B, and 3C.

FIG. 5E illustrates a press for a kit according to the seventh embodiment of the present invention, the press including a pestle and a support arrangement according to the first or the second embodiment received in a sleeve having a thread on its exterior surface, the sleeve being supported in a support platform as depicted in FIGS. 5A, 5B and 5C.

FIGS. 6A, 6B, and 6C show photographs of a sample that was successively deformed using a press in a kit according to the present invention.

### DETAILED DESCRIPTION OF EMBODIMENTS OF THE INVENTION

The present invention relates to a kit that includes at least one press configured for use with a microscope which can be used to press a sample while allowing the operator to observe the deformation of the sample with the microscope. A kit according to the present invention can include a single press and associated accessories, a plurality of different presses as disclosed herein, or a plurality of presses and associated accessories. In the most general terms a press in a kit according to the present invention includes a pestle which is positioned between the objective of a microscope and the sample to allow for the deformation and the observation of the sample by the operator. The pestle may be an optically transparent body or at least a body that includes an opening for the passage of light.

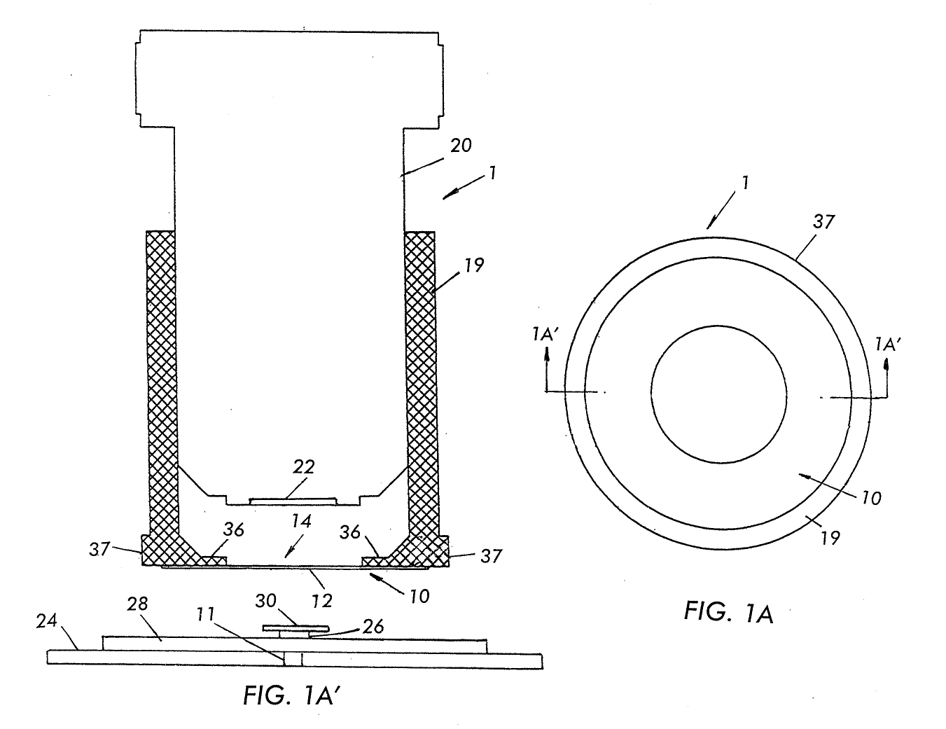

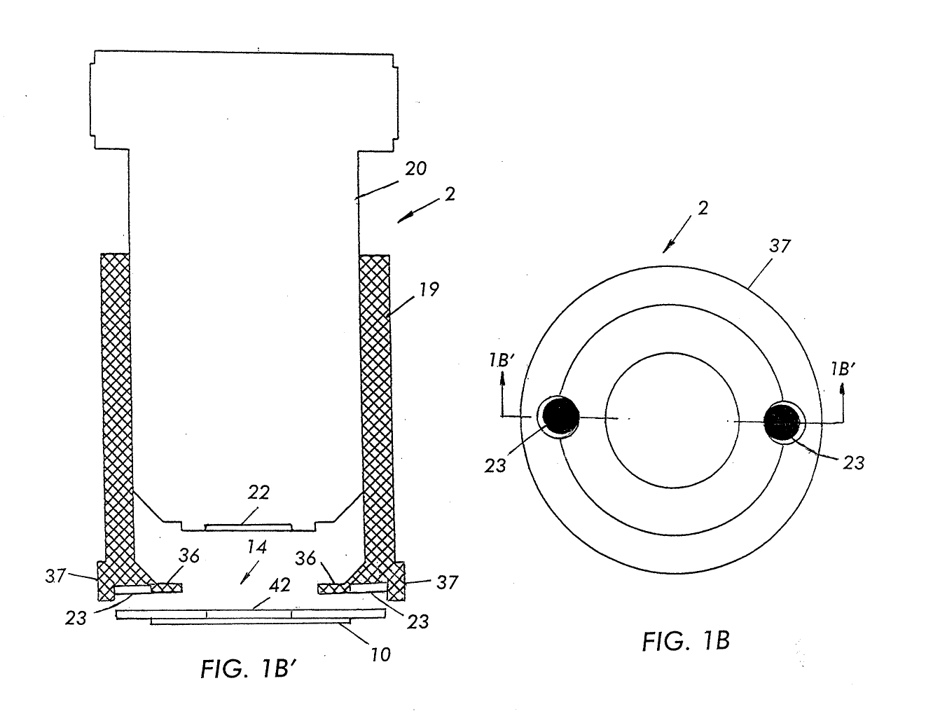

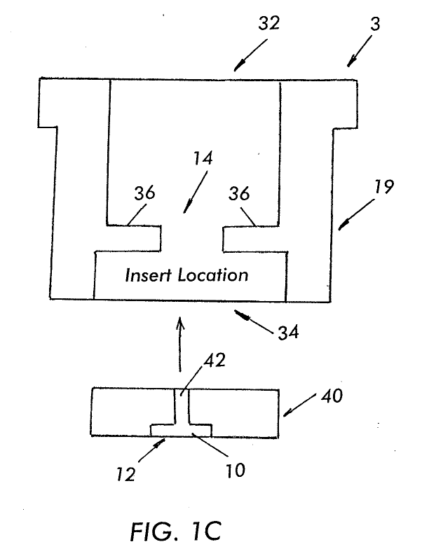

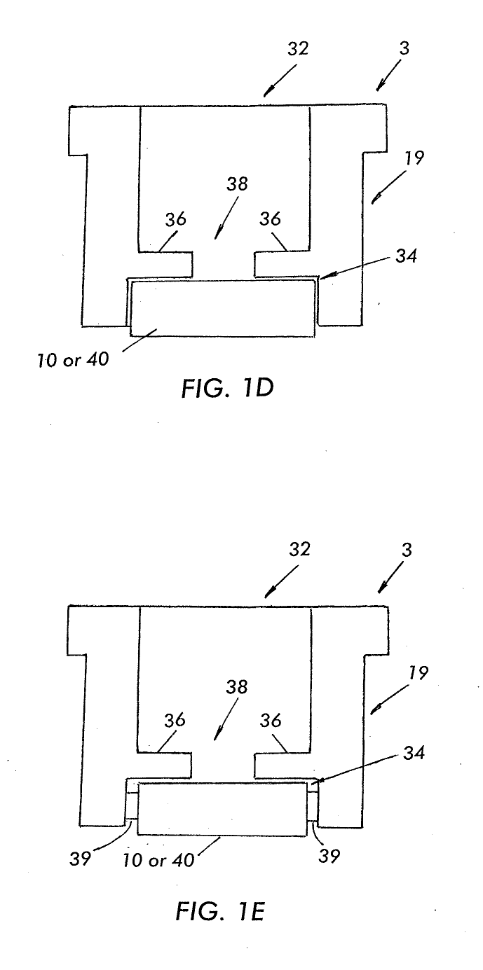

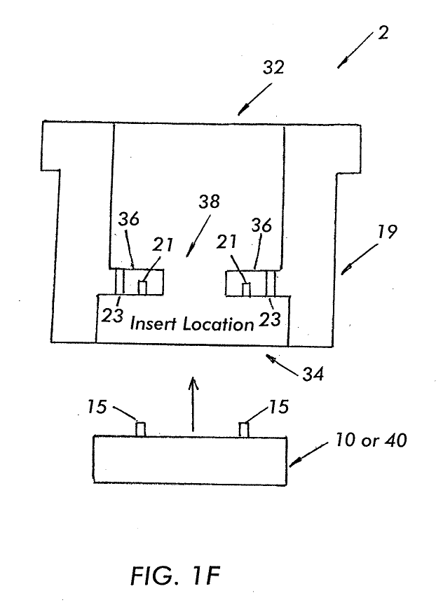

Referring to FIGS. 1A and 1A′, a press 1 in a kit according to a first embodiment of the present invention includes a pestle 10 having a bearing surface 12 and a support 19. Pestle 10 may be a glass cover slip as regularly used on microscope slides, or an optical window as shown in catalogs for optical supplies such as Edmund Optics. Support 19 in press 1 comprises a cylindrical body that includes an annular, continuous wall defining an interior space in which a microscope objective 20 is receivable. Support 19 may include an annular flange 36. Annular flange 36 extends radially into the interior of support 19 and is located at the distal end of support 19, which is opposite the end configured for receiving the objective of a microscope. Support 19 may further include a stop 37. Stop 37 may be an annular body which projects radially in a direction away from the interior of support 19. The purpose and function of stop 37 will be discussed later. Pestle 10, which may be a disk-shaped body, may at least rest on or may be, preferably, attached at its peripheral edge to annular flange 36 with an adhesive or the like, whereby pestle 10 is integrated with support 19. Pestle 10 may be attached to support 19 by a dissolvable glue (e.g. airplane glue) thus allowing for ready replacement. Thus, annular flange 36 serves as a surface for supporting pestle 10, may be attached to flange 36, or may serve to simply press pestle 10 if pestle 10 is not attached to flange 36. In any case, flange 36 o support 19 allows support 19 to engage pestle 10.

Annular flange 36 defines an aperture 14 to provide a light path to the objective 20 of a microscope, thus allowing the light that passes through pestle 10 to reach objective 20. Note that the interior surface of support 19 may be shaped to correspond to the exterior surface of objective 20 so that when objective 20 is fully received inside support 19 its distal end would be flush with the distal end of support 19. That way, not much additional space will be taken up by support 19 and pestle 10. Consequently, press 1 may be used with a short working distance objective.

In press 1, the interior diameter of cylindrical support 19 is about the same as the exterior diameter of objective 20 so that the interior surface of annular wall of support 19 frictionally couples to the exterior wall of objective 20 such that support 19 may be supported on objective 20 without another means, but may be slidably moved relative to objective 20 manually. Alternatively, if the diameter of support 19 is wider than the diameter of the objective 20, a wedge may be placed in the space between the two bodies so that support 19 may be secured to objective 20. A suitable wedge may be a pressure sensitive adhesive tape attached to the exterior surface of objective 20. Other means of supporting support 19 to objective 20 may include a clamp, or a radially oriented screw or pin received in a radially oriented orifice defined in support 19 to allow the screw or the pin to couple support 19 to objective 20. Alternative means of support should also allow support 19 to be supported on objective 20 such that it may be slidably moved relative to objective 20 manually so that the operator may pressure pestle 10 against a sample.

Manual sliding of support 19 relative to objective 20 may be carried out by gripping support 19 between two fingers (e.g. the thumb and the index fingers) and pushing support 19 away from the objective. Objective 20 may be part of a conventional light microscope. Objective 20 may include a lens 22 at the distal end thereof which can be oriented opposite the microscope's stage 24. Stage 24 is configured to receive a sample 26. Sample 26 preferably resides on a slide 28 (normally made with glass or the like material). Optionally, a cover slip 30 may be placed over sample 26, in which case cover slip 30 may function as a pestle 10. In this configuration, pestle 10 of press 1 may be kept in place or removed. If removed, flange 36 may bear directly against cover slip 30 (i.e. engage a cover slip), thus converting cover slip 30 to a pestle.

The illustrated arrangement allows the operator of the microscope to use the stage of the microscope and the slide to orient the sample directly opposite the objective lens 22 of the microscope. Sample 26 may be illuminated from above, or below slide 28 via a light aperture 11 provided in stage 24 as is well known in the art of microscopy.

Support 19 in this embodiment, due to its direct contact with, and frictional coupling to objective 20 supports pestle 10 in the space between objective lens 22 and sample 26, orients bearing surface 12 opposite sample 26, and aligns the light path defined by aperture 14 with the path of light that extends between sample 26 and objective lens 22 when bearing surface 12 is oriented opposite sample 26. The frictional coupling between the exterior surface of objective 20 and interior surface of annular wall of support 19 is configured so that support 19 may be manually moved by the operator along its longitudinal axis toward and away from sample 26 without moving objective 20 or stage 24, while still being capable of supporting pestle 10 in the space between objective lens 22 and sample 26 when support 19 is not being manually moved. Thus, support 19 allows pestle 10 to be moved toward and away from sample 26 independent of, and relative to objective 20, stage 24 and sample 26.

In a method according to the present invention, sample 26 is disposed on stage 24 in the manner described above. Namely, a sample, which can be anything that can be observed with a microscope, is disposed on a microscope slide 28, a glass cover slip 30 is optionally disposed over sample 26, and then the arrangement is placed on stage 24 such that sample 26 is in registration with objective lens 22. Alternatively, the cover slip 30 may be omitted and pestle 10 may be used as a cover slip. Support 19 may be slipped on the exterior surface of objective 20 before or after disposing sample 24 on stage 24 and optically registering the same with objective lens 22. In either case, the optical registration of sample 26 and objective lens 22 would result in a path of light that would extend from sample 26 to objective lens 22 through a light path in pestle 10 that continues through aperture 14. Thereafter, the operator can move pestle 10 toward sample 26 by urging support 19 along its longitudinal axis until pestle 10 makes contact with glass cover slip 30 or directly with sample 26 if no cover slip 30 is provided. Further motion of support 19 along its longitudinal axis would result in deforming sample 26, which can be observed by the operator through the eye piece of the microscope (not shown). Note that the operator may also rotate support 19 about its longitudinal axis while bearing surface 12 is in contact with cover slip 30 or in direct contact with sample 26 in order to observe the effect of shearing on sample 26. Naturally, the operator may move support 19, through its engagement with pestle 10, along its longitudinal axis while rotating it about its longitudinal axis and observe the effects of pressing and shearing on the sample at the same time. The slide may also be moved on the stage to observe the effects of shearing on sample 26 when sample 26 is pressed.

Advantageously, because support 19 is movable independently of objective 20 and stage 24, objective 20 may be focused properly independently of the position of pestle 10.

It should be noted that the rotation of pestle 10, may cause the cover slip to rotate as well, which results in shearing the sample. To avoid shearing the sample in this manner, lubrication may be applied to the bearing surface 12 of pestle 10 when a cover slip 30 is used.

Referring now to FIGS. 1B and 1B′, a press 2 in a kit according to the second embodiment of the present invention includes a support 19 which is configured to receive a plurality of different pestles 10. To enable support 19 to receive a plurality of different pestles, a pestle holder 40 is provided. Pestle holder 40 is adhesively coupled to an optically transparent pestle 10 (e.g. a glass cover slip) and includes a light shaft/opening 42 to allow for passage of light traveling through pestle 10. In this embodiment, pestle holder 40 is made of a magnetically susceptible material (e.g. steel). To allow pestle holder 40 to couple to support 19, one or more magnets 23 are provided at the distal end of support 19. Preferably each magnet 23 is received in a respective cradle defined in support 19 (e.g. defined inside annular flange 36). The thickness of magnets 23 and depth of the cradles in which magnets 23 are received may be configured so that magnets 23 will be flush with the surface of flange 36 on which holder 40 is mounted. Thus, pestle holder 40 may be coupled to support 19 by magnetically coupling to magnets 23. As can be readily appreciated magnets 23 allow for ready replacement of pestle holders 40 of different thickness that support different pestles 10.

Referring to FIG. 1C, a press 3 in a kit according to the third embodiment of the present invention includes a support 19 configured to have two open ends 32, 34. First open end 32 is configured to receive objective 20 of a microscope. Open end 34, which is opposite open end 32, is configured to receive a pestle holder 40. Note that an annular flange 36 may be provided inside support 19. Annular flange 36 may be a ring or the like body having an aperture 14 which is oriented to register with objective lens 22 as well as a light path in a pestle 10. A purpose of annular flange 36 is to prevent a pestle holder 40 received at opening 34 from advancing further into the interior space of support 19 than a pre-set depth and to provide support for a pestle 10 or a pestle holder 40. Note that while annular flange 36 may be an annular wall or a ring, one skilled in the art could replace annular flange 36 with a plurality of spaced abutments disposed around the longitudinal axis of support 19 without deviating from the scope and spirit of the present invention. In this embodiment, pestle holder 40 (or a pestle 10) may be glued in place by applying glue between its peripheral wall and an interior surface of support 19 located between open end 34 and flange 36 to attain a permanent coupling, pestle holder 40 (or a pestle 10) may be sized so that its peripheral wall frictionally couples to the interior surface of support 19 located between open end 34 and flange 36 to attain a semi-permanent coupling, or a plastic, flexible gasket 39 (e.g. an o-ring) or the like may be disposed around pestle holder 40 and interior surface of support 19 located between open end 34 and flange 36 in order to attain a readily detachable coupling between pestle holder 40 (or pestle 10) and the interior surface of support 19. FIGS. 1D and 1E illustrate how a pestle 10 or a pestle holder 40 (shown as 10 or 40) may be received at end 34 of a support 19 with (FIG. 1D) and without (FIG. 1E) a gasket 39. Specifically, FIG. 1D illustrates a pestle 10 or pestle holder 40 assembled by frictional coupling or glue and FIG. 1E illustrates a pestle 10 or pestle holder 40 assembled using a gasket 39, which resides between the interior wall of support 19 and the exterior peripheral wall of a pestle 10 or a pestle holder 40.

FIG. 1F illustrates a variation of a press 2 from the second embodiment. In this variation, pestle holder 40 (or pestle 10) may be provided with off-centered pins 15. Pins 15 are positioned to register with and dimensioned to be received in recesses 21 defined in annular flange 36. Once pins 15 are received in recesses 21 pestle 10 or pestle holder 40 is prevented from rotational movement relative to support 19.

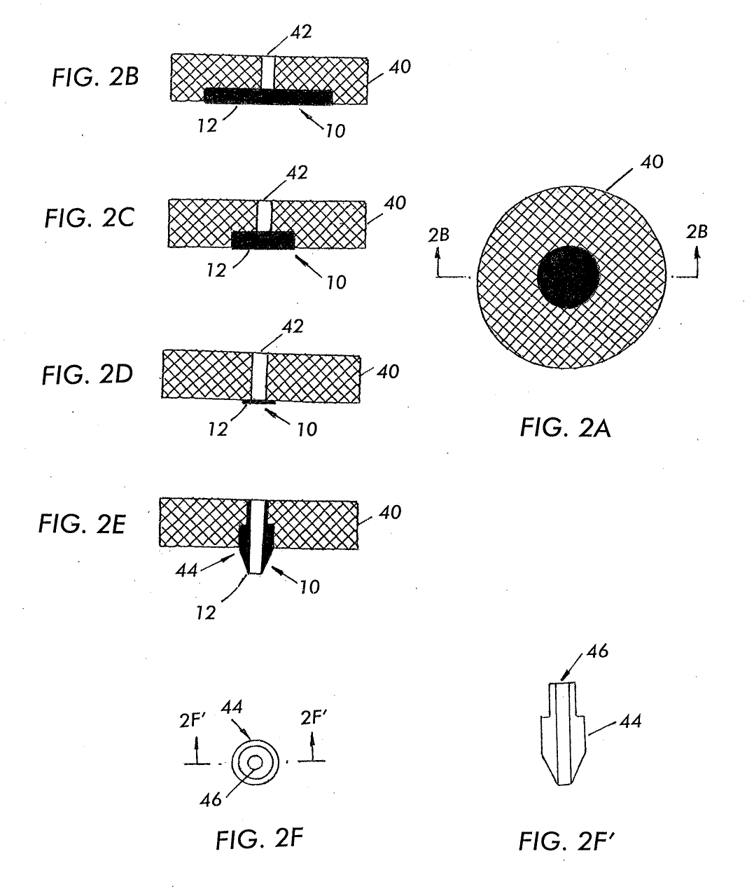

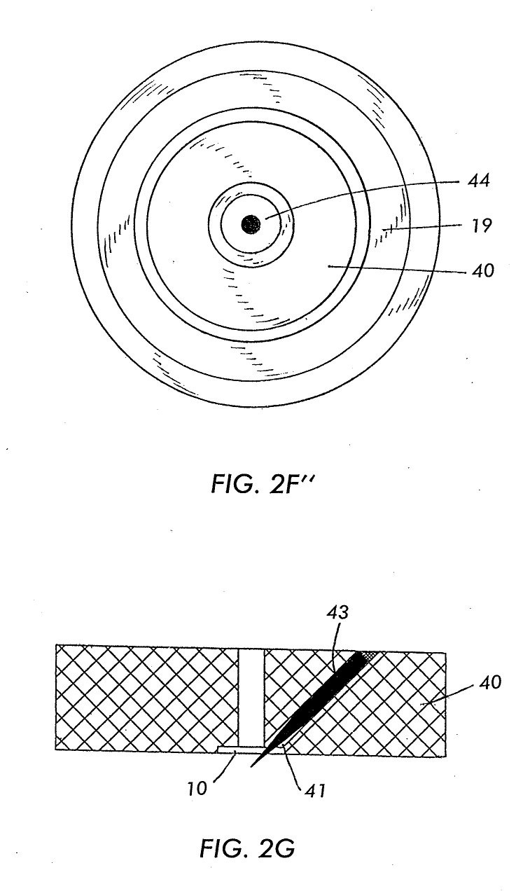

FIGS. 2A-2E illustrate a number of pestle and pestle holder arrangements which can be used with any of the presses disclosed herein that can accommodate a pestle holder 40. In the examples illustrated by FIGS. 2B, 2C, 2D, pestle holder 40 includes a light shaft 42 defined in its body. Light shaft 42 is positioned to register with interior opening 14 and objective lens 22 of the microscope when pestle holder 40 is received in support 19 and secured. In the examples illustrated in FIGS. 2B, 2C, and 2D, pestle holder 40 may be recessed in registration with light shaft 42 and a pestle 10 is received in the recess and preferably secured in place by glue or the like. In these examples, pestle 10 may be an optically transparent body that inherently includes a light path in the body thereof, which would register with light shaft 42. Pestle 10 in the examples shown by FIGS. 2B, 2C, 2D may be a borosilicate glass, sapphire or any optical window. For example, FIGS. 2B and 2C illustrate the use of disk-shaped borosilicate glass bodies as pestles 10. In FIG. 2B, pestle 10 may have a wider diameter than pestle 10 in the arrangement shown in FIG. 2C. Suitable pestles 10 for the examples shown by FIGS. 2B and 2C may be Borofloat NT 43-889 and Borofloat NT 43-888 respectively, both available from Edmund Optics Inc., 101 East Gloucester Pike, Barrington, N.J. 08007 (www.edmundoptics.com). FIG. 2D illustrates the use of a sapphire disk as a pestle 10. A suitable sapphire disk may be Sapphire NT 43-627 available from Edmund Optics Inc., 101 East Gloucester Pike, Barrington, N.J. 08007 www.edmundoptics.com.

Referring now to FIG. 2E, pestle holder 40 may receive a pen tip 44 without the ball. Pen tip 44 has a frusto conical distal end. Pen tip 44 is better illustrated in FIGS. 2F and 2F′. Note that the tip of frusto conical end is used as the bearing surface 12, while the hollow interior 46 of pen tip 44 defines the light path in pestle 10 shown in FIG. 2E. A suitable pen tip may be a pen tip from a pen sold by Parker (www.parkerpen.com). Alternatively, any cylindrical tube having guidable dimensions may be used.

Referring to FIG. 2H, in another variation, a pestle holder 40 may be provided with a needle shaft 41, which extends through pestle holder 40 at an angle (e.g. 45°). For example, the arrangement illustrated in FIG. 2D may be provided with a needle shaft 41. A needle 43 (e.g. a sewing needle or a Tungsten needle) may be inserted into needle shaft 41. The investigator may then use needle 43 to manipulate the sample under study. An investigator may also be able to use needle 43 without pressing the sample completely.

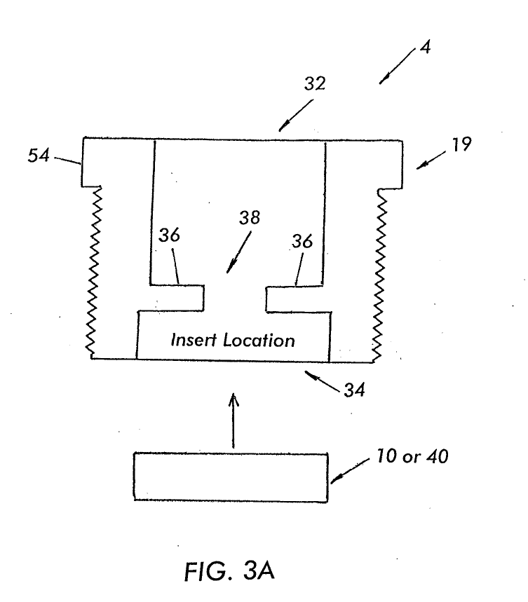

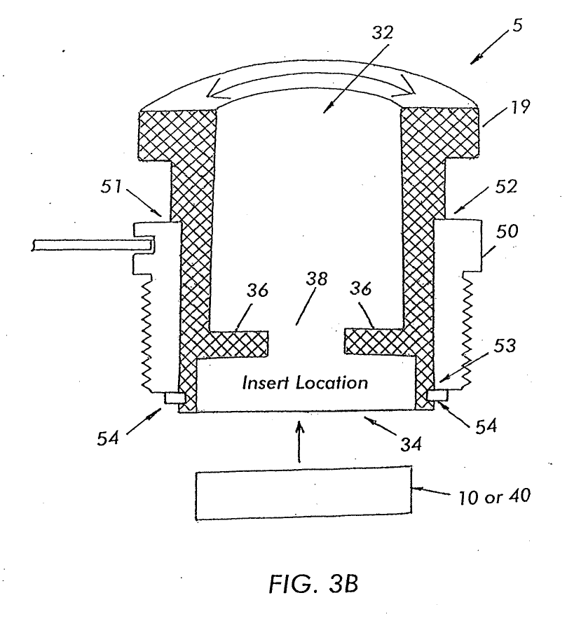

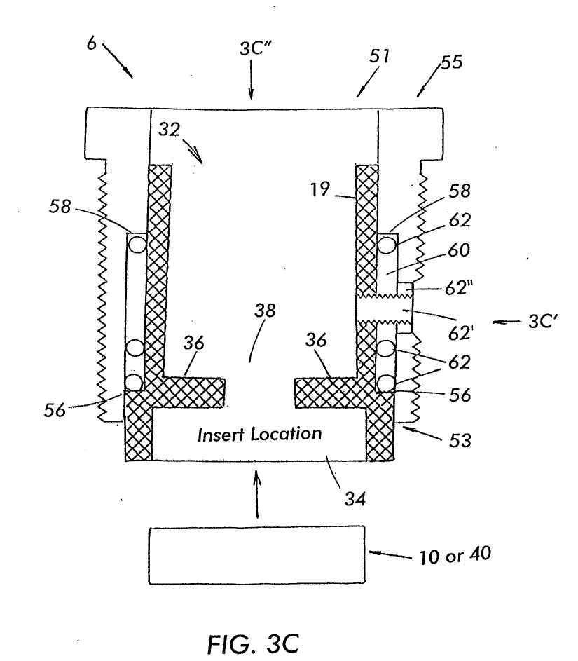

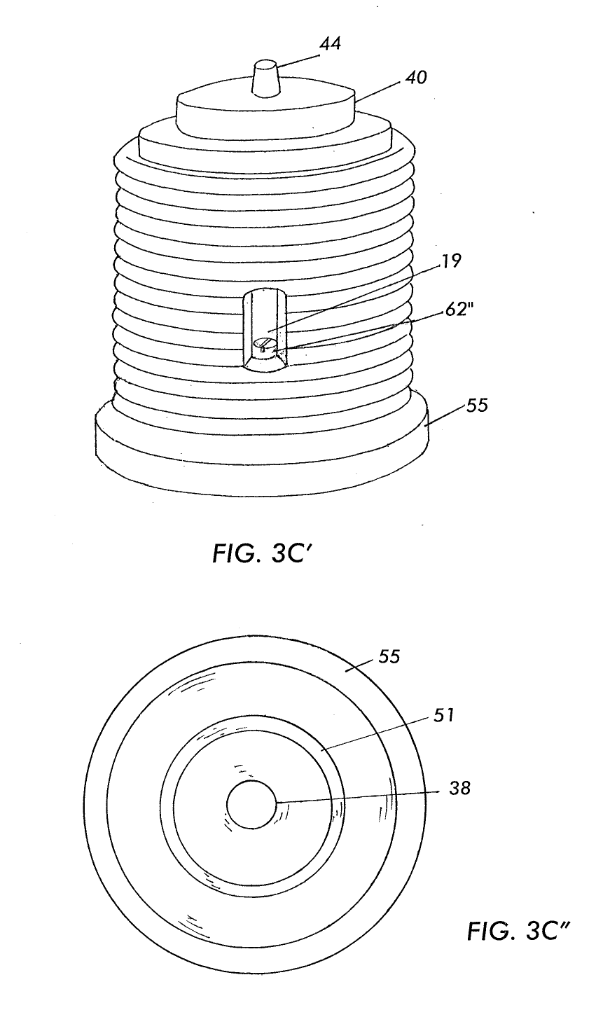

Referring to FIG. 3A, a press 4 in a kit according to the fourth embodiment of the present invention, may include a device having a support 19 with a first end 32 that is wider than the diameter of the objective that is received therein. Support 19 in this embodiment is configured to receive a pestle 10 or a pestle holder 40 (indicated by 10 or 40) at its second end 34. Pestle 10 or pestle holder 40 may be secured in the same manner as that described above with respect to press 3 in the third embodiment or, alternatively, magnets may be used to secure a pestle holder 40 in the same manner as that described above with respect to press 2 in the second embodiment. In this embodiment, the exterior surface of support 19 is threaded so that it may be received in a threaded opening of a support platform 48 in order to support a pestle 10, or pestle holder 40 according to the present invention as described below.

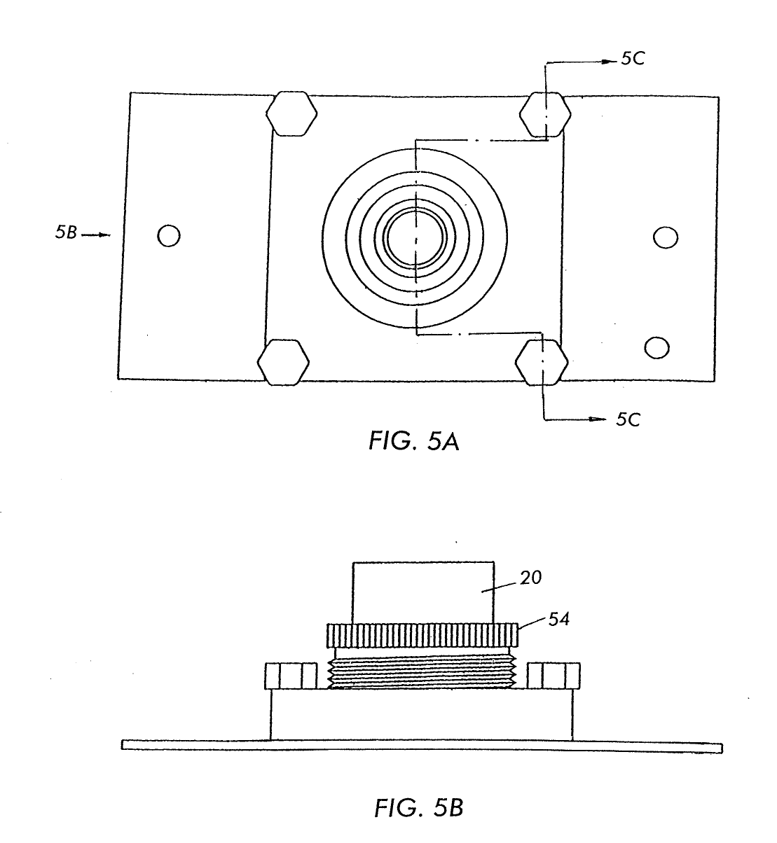

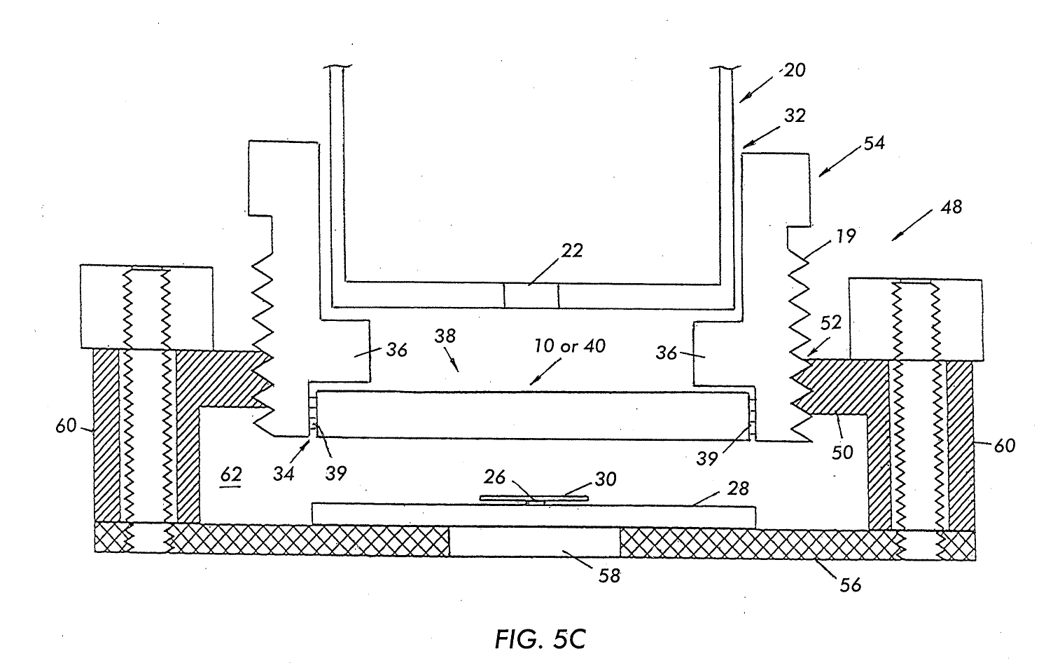

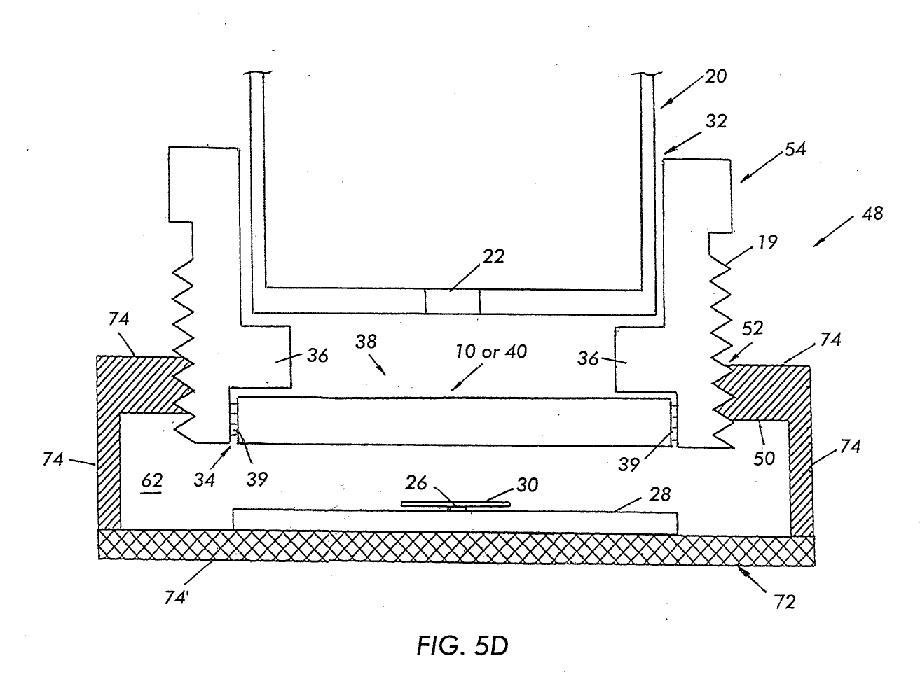

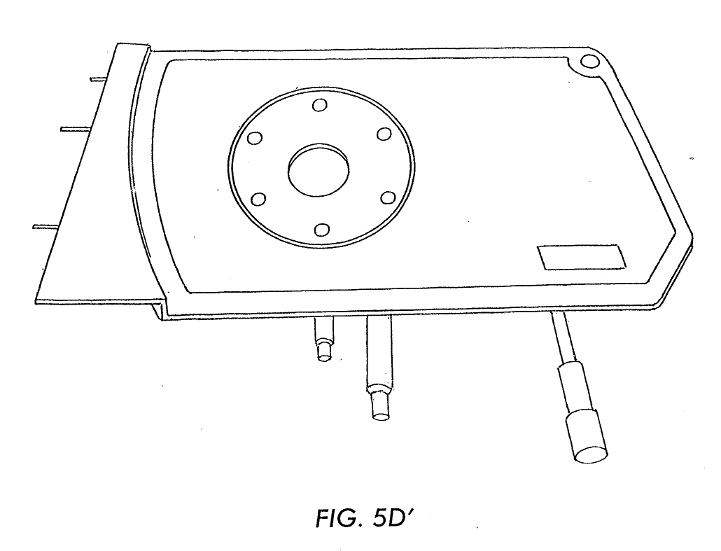

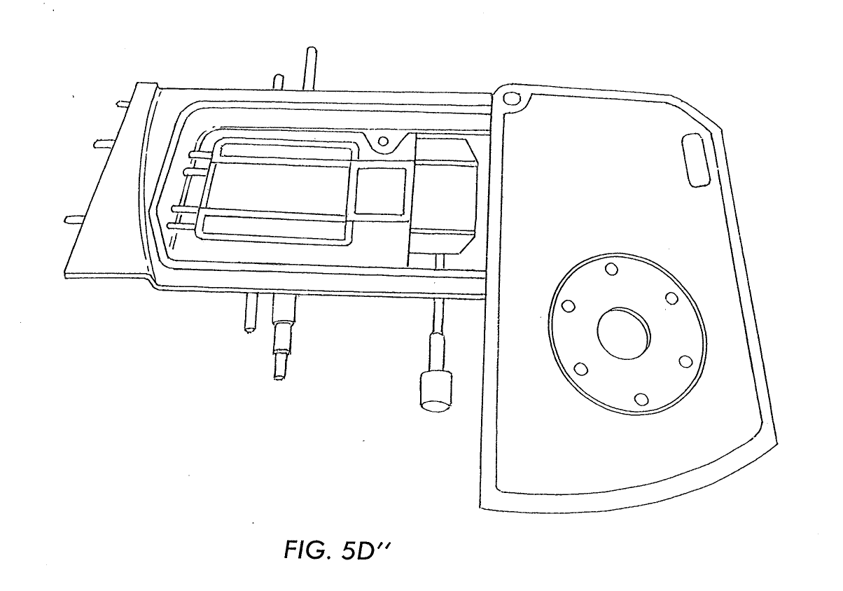

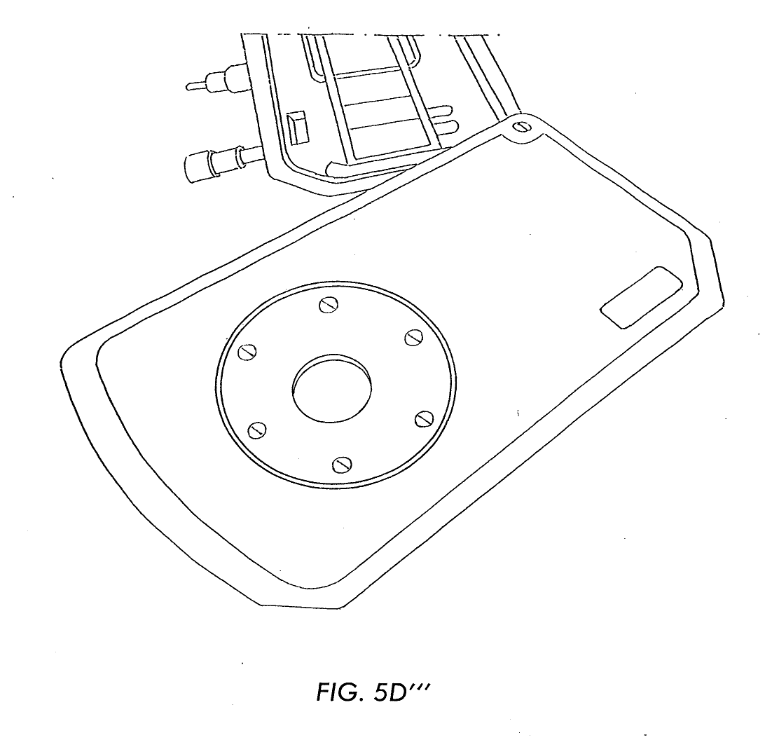

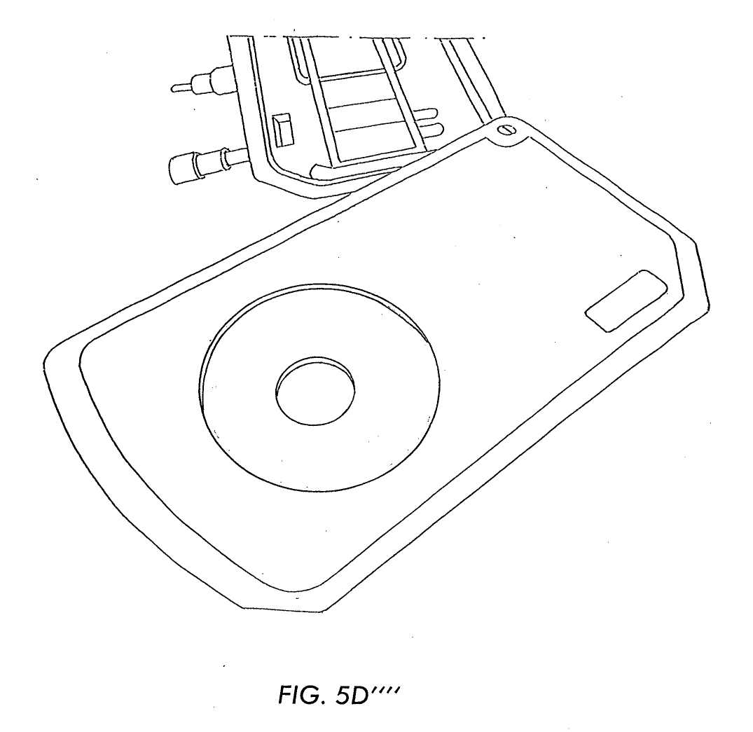

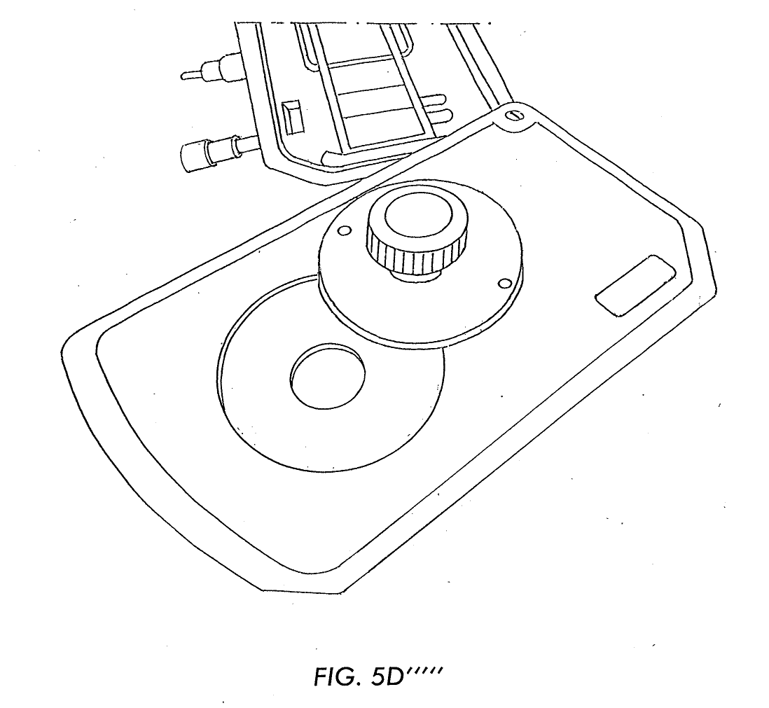

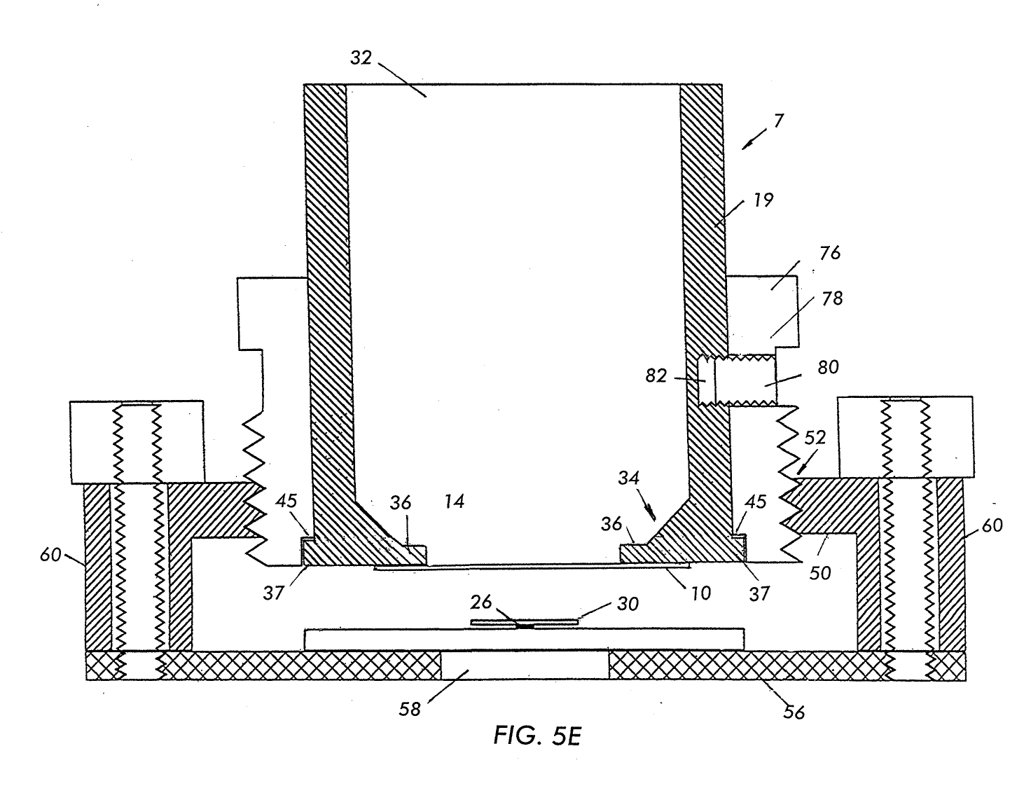

Referring to FIGS. 5A-5C, a support platform 48 for receiving a press 4 includes a web portion 50 in which an opening 52 is defined. The interior wall of opening 52 is provided with a thread complementary to the thread on the exterior surface of support 19 of press 4, whereby support 19 may be threadably received in opening 52. Thus, by rotating support 19 about its longitudinal axis support 19 may be inserted further into opening 52 or retracted from opening 52 depending on the direction of the rotation. To facilitate manual rotation of support 19 a head portion (e.g. knurl or a nut for a torque wrench) 54 may be provided at one end 32 of support 19.

Support platform 48 includes a sample platform (e.g. base plate) 56 having a light shaft 58 and spacers 60 which space the bottom surface of web portion 50 from the top surface of sample platform 56 in order to define a space 62 in which sample 26 is received. Note that sample platform 56 may be heated or cooled so that it may be used as a heated stage or a cooled stage. A suitable sample platform 56 may be a plate that is 0.063 inches thick, and 2″×4″. Support 19 may have a 0.75 inch diameter or any other suitable diameter and head portion 54 may have a one inch diameter or any other suitable dimension. Light shaft 58 may be devised to be as small as the field of view. A suitable diameter for light shaft 58 is 1.3 mm although other dimensions may be used without deviating from the present invention. In one working embodiment, web portion 50 and spacers 60 are a unitary body defined by milling out space 62 out of a 0.32 inch metallic plate.

Referring to FIG. 5D, in another alternative, a heated or cooled stage may be modified so that the heated or cooled stage itself becomes the sample platform. As illustrated, a heated/cooled stage 72 includes a chamber defined by a plurality of walls 74. A wall 74 opposite a sample receiving wall/platform 74′ may be provided with a threaded opening 52 residing over a sample 26. The threaded opening would receive a threaded support 19 in the same manner as web portion 50. A suitable heated/cooled stage that can be modified in this manner is THMS600 available from Linkham Scientific Instruments, United Kingdom. Referring to FIGS. 5D′-5D″″′, a Linkham heated/cooled stage 27 includes a lid 29 in the form of a removable ring, which can be screwed/unscrewed (compare FIGS. 5D′″ and 5D″″) to allow for maintenance. An adapter plate 31 (see FIG. 5D″″′) which is sized and shaped to replace lid 29 may be provided to receive support 19, and screwed in place of lid 29, whereby the stage may be used as a support platform as described above.

Referring back to FIG. 5C, in use, a slide 28 carrying sample 26 and slip 30 is placed over the top surface of sample platform 56 and positioned so that sample 26 registers with light shaft 58. Note that platform 48 may be placed on a microscope stage before or after sample 26 is positioned in place. A suitable light source (for example residing below the microscope's stage) serves as a source of light and illuminates the sample through light shaft 58. Support 19 is then axially rotated about its longitudinal axis using, for example, head portion 54 so that it is further inserted into opening 52 until pestle 10 makes contact with slip 30. Upon further rotation of support 19 in the same direction, force is imparted to cover slip 30, which causes slip 30 to move toward slide 28. Note that cover slip 30 may also rotate while moving toward sample 26. Consequently, sample 26 is pressed and sheared simultaneously. Upon suffering enough pressure from slip 30, sample 26 deforms. The deformation of sample 26 can be observed directly through objective 20. Thus, a press 4 may be used to deform a sample and used to observe the deformation of the sample simultaneously. Note that, as explained above, cover slip 30 is optional and may be removed to allow a pestle 10 to make direct contact with sample 26.

Referring to FIG. 3B, a press 5, in a kit according to the fifth embodiment of the present invention, includes a sleeve 50 used in cooperation with a support 19 to allow an operator to set the axial pressure against the sample, while allowing the sample to be sheared at the axial pressure. Specifically, sleeve 50 is a cylindrical body that is open at opposite ends 51, 53 (entry and exit ends respectively) and includes a threaded exterior surface which can be received in the threaded opening 52 of platform 48. Support 19 may be provided with an annular ledge 52 spaced from its open end 34. Ledge 52 is wide enough so that when support 19 is inserted in the interior space of sleeve 50, ledge 52 abuts the top surface of sleeve 50 at its entry end 51. Support 19 may be dimensioned so that its second end 34 exits sleeve 50 at exit end 53. One or more stops 54 are coupled to support 19 at second end 34 thereof to prevent support 19 from being axially withdrawn from sleeve 50. Thus, support 19 can be rotated about its longitudinal axis relative to sleeve 50, while rotation of sleeve 50 can move support 19 along its longitudinal axis toward, and away from the sample independent of the objective, the sample, and the stage. A radially-oriented spoke 25 may be coupled to sleeve 50. Spoke 25 may be used by the operator to hold sleeve 50 in place while support 19 is rotated. While one spoke 25 is shown, it should be understood that more than one spoke 25 may be coupled to sleeve 50 for the operator's convenience. Alternatively, sleeve 50 may be fixed against rotation by a screw or other implement. Rotational speed and the force imparted by support 19 may be measurable as well. To measure the rotational speed of support 19, support 19 may be driven externally by a belt or gears, or magnetically driven like the armature of a motor. A speedometer such as an automobile speedometer can be employed to measure the rotational speed. A strain gauge or the like device may be used to measure the applied force as well.

FIGS. 3C, 3C′ and 3C″ illustrate a press 6 in a kit according to the sixth embodiment of the present invention. Support 19 in press 6 may be spring-loaded to provide pressure on the sample along its longitudinal axis. To realize this embodiment, a cylindrical sleeve 55 having an entry end 51 and opposite exit end 53 may receive support 19 from its exit end 53. Support 19 may be provided with an annular ledge 56 around the exterior surface thereof. Annular ledge 56 is narrow enough to be received in the interior space of sleeve 55 from its exit end 53. By defining ledge 56, the exterior surface of support 19 is divided into a first region extending from open end 32 to ledge 56 and a second region extending from the ledge 56 to open end 34, the first region being narrower than the second region. An annular, radially oriented wall 58 is defined in the interior wall of sleeve 55. Wall 58 is defined to be opposite ledge 56 and divides the interior space of sleeve 55 into a first region (region between exit end 53 and wall 58) having a first diameter and a second region (region between wall 58 and entry end 51) having a second diameter, which is narrower than the first diameter. The first region of support 19 is dimensioned to have a diameter about equal to the diameter of the second region in sleeve 55 so that end 32 may fit snuggly in the second region. The second region of support 19 may have about the same diameter as the first region in sleeve 55 to fit tightly inside the first region of sleeve 55. The length of the first and second regions of sleeve 55 and support 19 are different to define an annular space 60 around support 19 between ledge 56 and wall 58. A coil spring 62 is disposed around support 19 inside space 60 between wall 58 and ledge 56 to spring load support 19. Note that sleeve 55 includes a threaded exterior surface so that it may be received in the threaded interior of opening 52 in platform 48. Thus, upon rotation of sleeve 55, and while a pestle 10 is in contact with the sample either directly or indirectly via a cover slip, support 19 may be moved along its longitudinal axis into the interior of sleeve 55, which results in compressing spring 62. The compression of spring 62 stores energy therein, which is then directed back to the pestle via support 19. Pressure on the sample is gradually increased through storage of energy in spring 62. Support 19 and sleeve 55 may be integrated (i.e. coupled to one another) by a side mounted screw 62′. Screw 62′ may be mounted in a manner that would allow the position of the screw to indicate the pressure applied by spring 62. For example, screw 62′ may be received in the body of support at one end, and received in a slot 62″ defined in the body of sleeve 55 at its opposite end. Screw 62′ may be tightened to prevent support 19 from movement relative to sleeve 55, or it may be loosened so that it may move along slot 62″. Thus, the position of screw 62′ along slot 62″ may indicate the pressure that is being applied by spring 62. Moreover, screw 62′ will abut the ends of slot 62″ thus preventing support 19 from being ejected from sleeve 55. In an alternative embodiment, a load cell may be used to measure the pressure that is being applied by spring 62.

Referring to FIG. 5E, a press 7 in a kit according to the seventh embodiment of the present invention includes a sleeve 76 having a threaded exterior surface that is threadably receivable in the threaded opening 52 of web portion 50. Sleeve 76 may include a radially extending orifice 78 having a threaded interior surface. A screw 80 or the like is threadably received in orifice 78. In this embodiment, any one of the devices having a smooth, non-threaded exterior surface (e.g. embodiments shown in FIG. 1A or 1B) may be received in sleeve 76. Thus, a device according to FIG. 1A, for example, may be inserted into sleeve 76 and used to deform a sample by axially turning sleeve 76. Note that support 19 may be provided with a blind hole 82 in which screw 80 is received, whereby sleeve 76 and support 19 are coupled to one another. Blind hole 82 may be replaced with a groove that is defined around the circumference of support 19, thus eliminating the need to align screw 80 with a hole, thereby making it easier for the operator to use the device. Stop 37 of support 19 may be received in a corresponding cut out defined in sleeve 76 to allow downward force to be applied by sleeve 79 to support 19. Stop 37 also prevents support 19 from further advancing into sleeve 76 beyond a predesignated point. To prevent support 19 from dropping until the operator is ready, screw 80 may be employed. A sleeve 76 thus allows a press as illustrated by FIG. 1A or FIG. 1B to be adapted for rotational deformation of a sample.

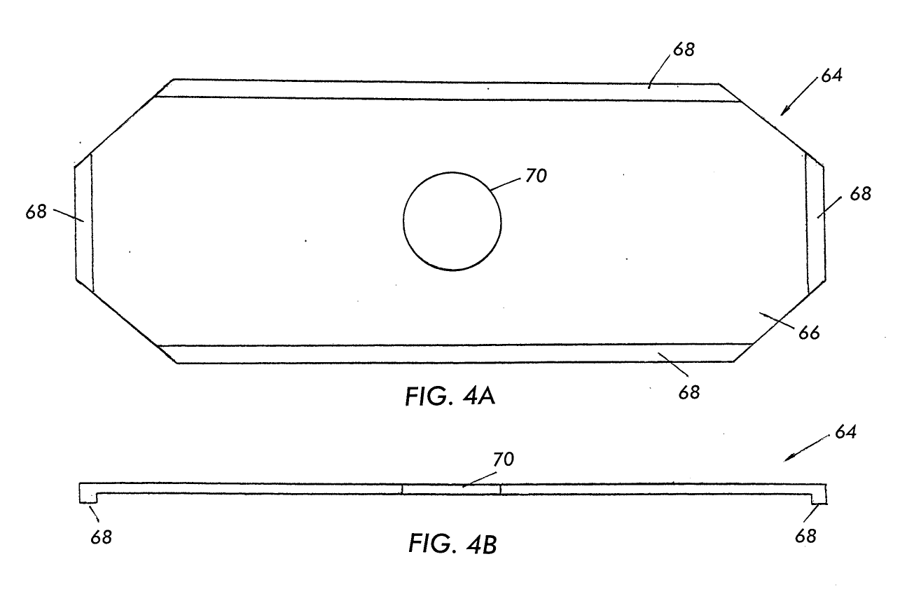

Referring now to FIGS. 4A and 4B, a kit according to the present invention may be further provided with a slide holder 64. Slide holder 64 may be a mechanically rigid body to provide further support for a glass slide 28. Thus, for example, slide holder 64 may be made of a suitable metallic body (e.g. steel or aluminum). Slide holder 64 may include an elongated web portion 66 having a plurality of vertical walls 68 extending from respective edges thereof, and arranged (i.e. spaced from one another) to abut the side edges of a slide in order to prevent its lateral and rotational movement. An opening 70 may be defined in web portion 66 to allow for the passage of light. Note walls 68 are not connected to one another to allow the operator to access the corners of a rectangular slide that is placed on web portion 66. To facilitate easy removal of a glass slide web portion 66 does not provide support for at least one corner (and preferably all corners) of a rectangular glass slide. Thus, as illustrated, web portion 66 may be an elongated hexagon having pairs of opposing walls 66 to prevent the lateral motion of a glass slide placed thereon.

In all embodiments the pestle is sized to fit between the objective and the sample. Thus, the pestle is thinner than the working distance. A kit according to the present invention may include devices having pestles and/or pestle holders of various thicknesses.

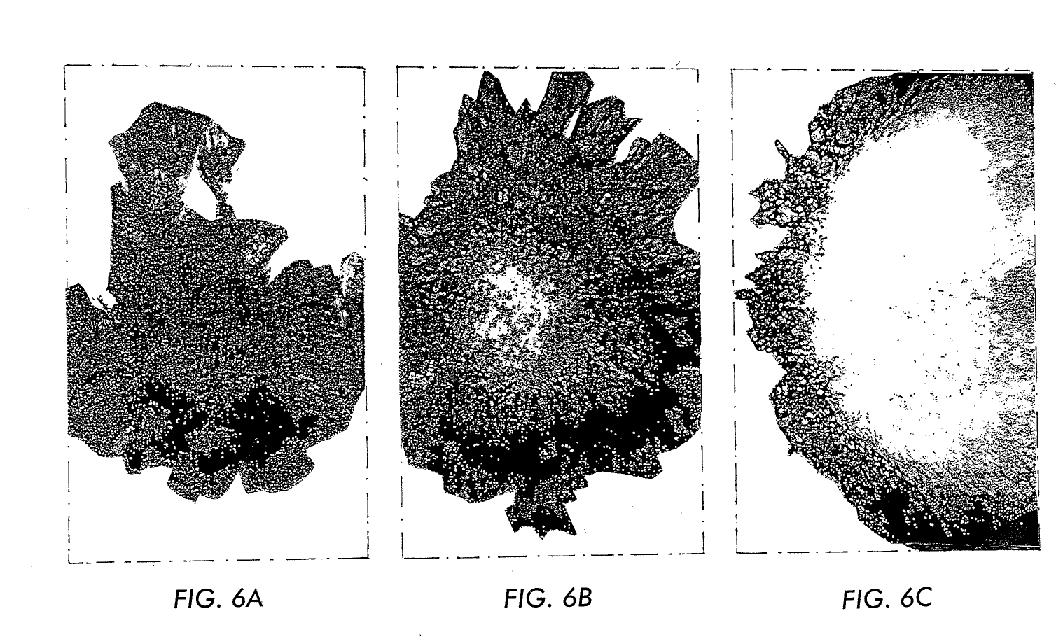

FIGS. 6A, 6B and 6C show photographs of a wax particle that has been successively pressed using a press from a kit according to the present invention. Crystalline wax was chosen for illustration because the change in birefringence shows the effect of non-confined pressing so clearly. It should be noted, however, that other materials may also be studied without deviating from the scope and the spirit of the present invention.

A method according to the present invention will allow the observation of deformation of materials with the potential of relating these observations to rheological data. Well known measuring equipment can be incorporated to enable collection and display of rheological data while the observation is taking place.

A suitable microscope objective for use with a press from a kit according to the present invention may have a Leitz long working distance objective marked L 10/0.22 (L stands for long working dist., 10 for 10× magnification and /0.22 for numerical aperture, a measure of resolving power and depth of field). This objective has a working distance of 15.5 mm and a field of view of 1.4 mm. Another suitable objective may be Leitz 10/0.25 P (P means that the objective corrected to not be affected by polarized light). This objective has a working distance of 6.7 mm and a field of view of 1.9 mm. As noted above, press 1 and press 2, for example, can be used with objectives having even shorter working distances.

Almost any objective can be adapted for use with a device according to the present invention, even oil immersion, but very short working distance objectives will limit the amount of pressure that can be applied. Normal 10× objectives are well suited for use with a device according to the present invention. Long working distance objectives can be advantageous depending on the application. Higher magnification results in shorter working distance, and generally higher numerical aperture thus less depth of field. A press from a kit according to the present invention can also be adapted to a range of microscopical techniques including, for example, bright field and dark field, transmitted and reflected light, phase contrast, interference contrast, polarized light, confocal microscopy.

While pressing has been used to demonstrate a mode for deforming a material sample, a press from a kit according to the present invention may be used to observe other deformation modes. For example, wearing of materials known for their tribological characteristics may be studied using a device according to the present invention. An example would be the wear of coatings studied by devices such as the “Taber Abrader”. Another example would be the observation of paper rubbing ink, a property that confounds printers, ink makers, and those buying printed materials. Paper rubbing is routinely studied in the USA with a device known as the Sutherland rub tester (and in other countries by similar devices). A press from a kit according to the present invention may be used to apply the necessary pressure while the test is carried out.

Note that in addition or instead of a hot stage a heating filament may be used to heat the sample. The arrangement would be similar to a heating filament incorporated in the window of a car.

In addition, an optical fiber may be provided to provide illumination to a sample, which may be useful when studying an opaque sample. Note that the optical fiber may be outside of the device or incorporated with the support to provide light through the pestle or pestle holder to the sample from above the stage.

Furthermore, a press from a kit according to the present invention may be used along with a device (e.g. a strain gauge or a pressure gauge) to gauge the pressure that is being applied to the sample. For example, a pressure sensitive film may be arranged between the slide and the stage to supply information about the amount of pressure and the uniformity of the pressure that is being applied by the pestle. Other devices (e.g. torque wrenches) may also be used to measure the applied pressure.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A kit that comprises at least a press for a light microscope, the microscope including an objective having a lens at a distal end thereof, and a stage configured to receive a sample and to orient the sample directly opposite the objective lens, the press comprising:
a pestle having a bearing surface, and a light path extending from the bearing surface through its body; and
a support that engages the pestle and enables the movement of the pestle independent of and relative to the objective, the sample, and the stage; wherein the support is configured to align the light path with a path of light that extends between the sample and the lens of the objective when the bearing surface of the pestle is positioned to press the sample.

2. A kit according to claim 1, wherein the pestle comprises a flat bearing surface.

3. A kit accessory according to claim 2, wherein the light path is defined by an opening in the pestle.

4. A kit according to claim 2, wherein the pestle is comprised of an optically transparent material.

5. A kit according to claim 1, wherein the pestle comprises a frusto-conical body.

6. A kit according to claim 1, wherein the support comprises a body having an interior space that is large enough to at least partially receive the objective.

7. A kit according to claim 1, wherein the support includes an interior wall adjacent the interior space that is configured to frictionally couple to an exterior surface of the objective.

8. A kit according to claim 1, wherein the support comprises a cylindrical body having a threaded exterior surface cooperatively receivable in a threaded interior surface of an opening of a platform having spacers, the spacers having a height less than the space between the objective lens and the sample.

9. A kit according to claim 1, wherein the support comprises a cylindrical body having a threaded exterior surface and further comprising a platform having a threaded opening configured for engagement with the threaded exterior surface, the platform further including spacers having a height less than the space between the objective lens and the sample.

10. A kit according to claim 1, wherein the pestle is spring loaded.

11. A kit according to claim 1, further comprising a pestle holder, the pestle being coupled to the pestle holder and the pestle holder being configured to engage with the support.

12. A kit according to claim 1, wherein the pestle holder is magnetically susceptible.

13. A kit according to claim 1, further comprising a sleeve having a threaded exterior surface and an interior space configured to receive the support.

14. A kit according to claim 13, wherein the sleeve and the support are configured to be coupled to one another by a fastener.

15. A kit according to claim 14, wherein the fastener is receivable in a slot defined in the support.

16. A kit according to claim 1, further comprising a pestle holder to hold the pestle, the pestle holder including a needle shaft defined in its body configured and sized to receive a needle.

17. A kit according to claim 16, further comprising a slide holder that includes a web portion having a plurality of walls extending from edges thereof and an opening to allow for passage of light, the walls being arranged to abut the edges of a microscope slide.

18. A kit according to claim 1, further comprising a plurality of pestles, each pestle having a thickness different than a thickness of the pestle.

19. A kit according to claim 1, further comprising a plurality of pestles, each pestle having a diameter different than a diameter of the pestle.

20. A method of observing the effect of deformation on a sample, comprising:
disposing the sample on a stage of a microscope in optical registration with an objective of the microscope;
arranging a pestle having a light path therein and a bearing surface between the sample and the objective; and
deforming the sample with the bearing surface while observing the sample through the objective.

21. The method of claim 20, wherein the pestle is frictionally supported on the objective and the deforming includes manually moving the pestle relative to the objective from the objective toward the sample.

22. The method of claim 20, wherein the pestle is spring loaded and the deforming includes placing the bearing surface in contact with the sample.

23. The method of claim 20, further comprising arranging the pestle between the sample and the objective by a support integrated with the pestle, the support having a threaded exterior surface that engages with a threaded interior surface of an opening in a platform arranged between the sample and the objective, the deforming including rotating the support about its longitudinal axis.

24. The method of claim 20, wherein the pestle comprises a flat bearing surface.

25. The method of claim 24, wherein the light path is defined by an aperture in the pestle.

26. The method of claim 24, wherein the pestle is comprised of an optically transparent material.

27. The method of claim 20, wherein the pestle comprises a frusto-conical body.

28. The method of claim 20, wherein the support comprises a body having an interior space that is large enough to at least partially receive the objective.

29. The method of claim 20, further comprising heating or cooling the sample.

30. The method of claim 20, further comprising deforming the sample with a needle.

31. The method of claim 20, wherein said deforming includes shearing the sample.

32. The method of claim 20, wherein said deforming includes compressing the sample.

33. The method of claim 20, wherein said deforming includes compressing and shearing the sample simultaneously.
